(19) United States
(12) Patent Application Publication
(10) Pub. No.: US 2012/0099556 A1
(43) Pub. Date: Apr. 26, 2012

(54) METHOD FOR RECONFIGURING USER BITMAP IN WIRELESS ACCESS SYSTEM

(75) Inventors: Jeong Ki Kim, Gyeonggi-do (KR); Young Soo Yuk, Gyeonggi-do (KR)

(73) Assignee: LG ELECTRONICS INC., Seoul (KR)

(21) Appl. No.: 13/380,719

(22) PCT Filed: Jun. 25, 2010
(86) PCT No.: PCT/KR10/04167

§ 371 Date: Dec. 23, 2011

Related U.S. Application Data
(60) Provisional application No. 61/220,592, filed on Jun. 26, 2009.
(60) Provisional application No. 61/225,178, filed on Jul. 13, 2009.
(60) Provisional application No. 61/224,922, filed on Jul. 13, 2009.

(30) Foreign Application Priority Data
Jun. 25, 2010 (KR) 10-2010-0060852

(51) Int. Cl. H04W 72/04

(52) U.S. Cl. 370/329

(57) ABSTRACT

Disclosed are methods for reconfiguring a user bitmap in a group resource allocation method and apparatuses for supporting the same. In one embodiment of the present invention, the methods for reconfiguring the user bitmap in group resource allocation (GRA) may comprise the steps of receiving a control signal that includes a mobile indicator for indicating whether user bitmap is reconstructed from a base station, a user bitmap state bitmap (UBSB) for indicating scheduled and non-scheduled terminals which belong to the GRA, and the user bitmap for indicating the scheduled terminal, determining on the basis of the control signals whether the user bitmap is reconfigured, and reconfiguring the user bitmap by using the UBSB and the user bitmap.

### TECHNICAL FIELD

The present invention relates to a method for allocating group resources used in a wireless access system, and more particularly, to methods for reconfiguring a user bitmap in a group resource allocation method and apparatuses for supporting the same.

### BACKGROUND ART

A group resource allocation (GRA) method is to allocate resources to several users (i.e., user equipments) belonging to one group, so as to reduce overhead of a control message transmitted from a base station to a user equipment. If the GRA method is used, since the base station may transmit control information compressed in a group unit to the user equipments when separately allocating resources to the user equipments, signaling overhead within a network may be reduced.

The base station may use group control information to allocate and configure resources to one or more user equipments belonging to one group. Here, the group control information may be referred to as advanced MAP or A-MAP. For user specific control information for a single user or user group, multiple information elements are separately coded for the A-MAP. Also, the A-MAP is transmitted by CRC masking with ID (for example, STID of a specific user equipment, broadcast STID and/or multicast STID) of the user equipment.

Since the A-MAP is transmitted by separate encoding and masking with STID, the user equipment performs blind decoding for a region to which the A-MAP is transmitted, to identify whether there is any A-MAP transmitted thereto. Here, the user equipment may detect the A-MAP by using STID allocated thereto, broadcast STID and/or multicast STID (for example, group ID, persistent ID, sleep/idle mode ID or MBS ID).

The user equipment performs blind decoding on the basis of MAP size used in the corresponding system. Here, the base station and/or the user equipment may restrict the size and type of the MAP to specific sizes and types to reduce the number of times for blind decoding. For example, the base station and/or the user equipment may restrict the size of the A-MAP information element (IE) to either three sizes such as 56 (or 64), 96 and 144, or two sizes such as 56 (or 64) and 96.

It is assumed that one minimum A-MAP logical resource unit (MLRU) includes 48 data subcarriers, two MLRUs include 96 data subcarriers, and the size of the A-MAP IE is determined to 56 or 96. Here, the base station may map 56 bit A-MAP IE into 1 MLRU and 96 bit A-MAP IE into 2 MLRUs by using an encoding method (for example, tail-biting convolutional code (TBCC) or puncturing scheme) for a downlink control channel, and may transmit the mapped data to the user equipment.

### DISCLOSURE

### Technical Problem

An object of the present invention is to provide a method for efficient group resource allocation.

Another object of the present invention is to provide methods for reconfiguring a user bitmap in a group resource allocation method.

Still another object of the present invention is to provide a method for reconfiguring a user bitmap semi-dynamically.

Further still another object of the present invention is to provide apparatuses for supporting a group resource allocation method.

It will be appreciated by persons skilled in the art that the objects that could be achieved with the present invention are not limited to what has been particularly described hereinabove and the above and other objects that the present invention could achieve will be more clearly understood from the following detailed description.

### Technical Solution

To solve the aforementioned technical problems, the present invention discloses group resource allocation methods used in a wireless access system. In particular, the present invention discloses methods for reconfiguring a user bitmap in a group resource allocation method and apparatuses for supporting the same.

In one embodiment of the present invention, a method for reconfiguring a user bitmap in group resource allocation (GRA) comprises the steps of receiving a control signal from a base station, the control signal including a shifting indicator for indicating whether the user bitmap should be reconfigured, a user bitmap status bitmap (UBSB) for indicating scheduled user equipments and non-scheduled user equipments, which belong to the GRA, and the user bitmap for indicating the scheduled user equipments; determining on the basis of the control signal whether the user bitmap should be reconfigured; and reconfiguring the user bitmap by using the UBSB and the user bitmap.

In another aspect of the present invention, a method for reconfiguring a user bitmap in group resource allocation (GRA) comprises the steps of determining whether the user bitmap should be reconfigured; transmitting a control signal that includes a shifting indicator for indicating whether the user bitmap should be reconfigured, a user bitmap status bitmap (UBSB) for indicating scheduled user equipments and non-scheduled user equipments, which belong to the GRA, and the user bitmap for indicating the scheduled user equipments; and receiving one of an acknowledgement (ACK) signal for downlink data burst, ACK signal for uplink data burst and ACK signal for the control signal after transmitting the control signal.

In still another aspect of the present invention, a user equipment for reconfiguring a user bitmap in group resource allocation (GRA) comprises a receiving means (e.g., receiving module) receiving a control signal from a base station, the control signal including a shifting indicator for indicating whether the user bitmap should be reconfigured, a user bitmap status bitmap (UBSB) for indicating scheduled user equipments and non-scheduled user equipments, which belong to the GRA, and the user bitmap for indicating the scheduled user equipments; a determining means (e.g., processor) determining on the basis of the control signal whether the user bitmap should be reconfigured; and a reconfiguring means (e.g., processor or MAC entity) reconfiguring the user bitmap by using the UBSB and the user bitmap.

In the aforementioned aspects of the present invention, the control signal may further include a retransmission flag indicating whether the control signal is initially transmitted or retransmitted, and a retransmission bitmap indicating a user equipment which should reconfigure the user bitmap. Also, the control signal may further include a number (NDA) field indicating the number of deleted user equipments in the GRA, a user bitmap index field indicating a user bitmap index of the deleted user equipments, and a user bitmap size field indicating a length of the UBSB. In the embodiments of the present invention, the control signal may be a group resource allocation A-MAP information element.

The aforementioned embodiments of the present invention are only a part of the preferred embodiments of the present invention, and various embodiments in which technical features of the present invention are reflected may be devised and understood based on the detailed description of the present invention, which will be described later, by the person with ordinary skill in the art.

### Advantageous Effects

According to the embodiments of the present invention, the following advantages may be obtained.

First of all, a base station may efficiently allocate group resources in accordance with the present invention.

Second, as a semi-static (or semi-dynamic) user bitmap size is set, the number of times for shift of a user bitmap index may be reduced when user equipments are deleted from a group.

It will be appreciated by persons skilled in the art that that the effects that could be achieved with the present invention are not limited to what has been particularly described hereinabove and other advantages of the present invention will be more clearly understood from the following detailed description. In other words, advantages or effects not intended by the present invention may be devised from the embodiments of the present invention by the person with ordinary skill in the art.

### BRIEF DESCRIPTION OF THE DRAWINGS

FIG. 1 is a diagram illustrating an example of a group resource allocation method based on a bitmap;

FIG. 2 is a diagram illustrating an example of a fixed user bitmap and a variable user bitmap;

FIG. 3 is a diagram illustrating one of methods for reconfiguring a bitmap in accordance with the embodiment of the present invention;

FIG. 4 is a diagram illustrating one of methods for reconfiguring a bitmap if a user bitmap status bitmap (UBSB) is initially transmitted in accordance with the embodiment of the present invention;

FIG. 5 is a diagram illustrating a user bitmap reconfigured in FIG. 4 in accordance with the embodiment of the present invention;

FIG. 6 is a diagram illustrating another one of methods for reconfiguring a bitmap if a UBSB is retransmitted in accordance with the embodiment of the present invention;

FIG. 7 is a diagram illustrating an example of an initial user bitmap used together with a deletion bitmap in accordance with the embodiment of the present invention;

FIG. 8 is a diagram illustrating an example of a retransmitted user bitmap used together with a deletion bitmap in accordance with the embodiment of the present invention;

FIG. 9 is a diagram illustrating that there is no shift of a user equipment, which is caused by reconfiguration of a user bitmap of the user equipment, and there is no user equipment deleted from a corresponding group;

FIG. 10 is a diagram illustrating that user equipments are deleted from a corresponding group in accordance with the embodiment of the present invention;

FIG. 11 is a diagram illustrating that deleted user equipments and shifted user equipments exist in accordance with the embodiment of the present invention; and

FIG. 12 is a diagram illustrating a user equipment and a base station through which the embodiments of the present invention described in FIG. 2 to FIG. 11 can be carried out, in accordance with the embodiment of the present invention.

### BEST MODE FOR CARRYING OUT THE INVENTION

The embodiments of the present invention disclose methods for reconfiguring a user bitmap in a group resource allocation method and apparatuses for supporting the same.

The following embodiments are achieved by combination of components and features of the present invention in a predetermined type. Each of the components or features should be considered selectively unless specified separately. Each of the components or features may be carried out without being combined with other components or features. Also, some components and/or features may be combined with one another to constitute the embodiments of the present invention. The order of operations described in the embodiments of the present invention may be changed. Some components or features of one embodiment may be included in another embodiment, or may be replaced with corresponding components or features of another embodiment.

In the description of drawings, procedures or steps that may make the subject matter of the present invention obscure will not be disclosed. Also, procedures or steps that may be understood by the person with ordinary skill in the art will not be disclosed.

In this specification, the embodiments of the present invention have been described based on the data transmission and reception between a base station and a mobile station. In this case, the base station means a terminal node of a network, which performs direct communication with the mobile station. A specific operation which has been described as being performed by the base station may be performed by an upper node of the base station as the case may be.

In other words, it will be apparent that various operations performed for communication with the mobile station in the network which includes a plurality of network nodes along with the base station may be performed by the base station or network nodes other than the base station. Here, the base station (BS) may be replaced with terms such as a fixed station, Node B, eNode B (eNB), and an access point (AP).

Also, the mobile station may be replaced with terms such as a user equipment (UE), a subscriber station (SS), a mobile subscriber station (MSS), a mobile terminal (MT), an advanced mobile station (AMS), a terminal and a user.

Furthermore, a transmitting side means a fixed and/or mobile node that provides data services or voice services while a receiving side means a fixed and/or mobile node that receives data services or voice services. Accordingly, in an uplink, the mobile station could be a transmitting side while the base station could be a receiving side. Likewise, in a downlink, the mobile station could be a receiving side while the base station could be a transmitting side.

The embodiments of the present invention can be supported by standard documents disclosed in at least one of wireless access systems, i.e., IEEE 802.xx system, 3GPP system, 3GPP LTE system, and 3GPP2 system. Namely, among the embodiments of the present invention, apparent steps or parts which are not described may be described with reference to the above documents.

Also, all terminologies disclosed herein can be described by the above standard documents. Particularly, the embodiments of the present invention can be supported by one or more of standard documents of IEEE 802.16 system, i.e., P802.16e-2004, P802.16e-2005, P802.16Rev2, and P802.16m.

Hereinafter, the preferred embodiments of the present invention will be described with reference to the accompanying drawings. It is to be understood that the detailed description, which will be disclosed along with the accompanying drawings, is intended to describe the exemplary embodiments of the present invention, and is not intended to describe a unique embodiment with which the present invention can be carried out.

Also, specific terminologies hereinafter used in the embodiments of the present invention are provided to assist understanding of the present invention, and various modifications can be made in the specific terminologies within the range that they do not depart from technical spirits of the present invention.

I. Group Resource Allocation (GRA)

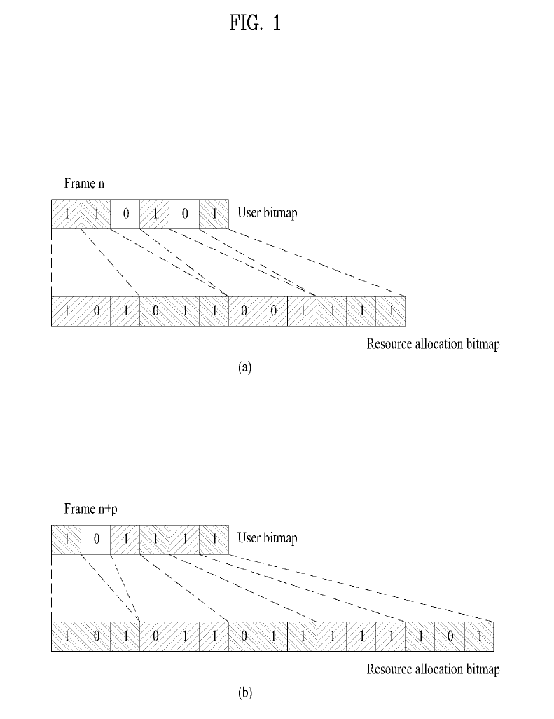

FIG. 1 is a diagram illustrating an example of a group resource allocation method based on a bitmap.

In order to notify user equipments belonging to a predetermined group of resource allocation information, bitmaps may be used. Referring to FIG. 1, a user bitmap which is the first bitmap represents what user equipment is scheduled from the corresponding group at the corresponding time. Each bit of the user bitmap corresponds one-to-one to the user equipments belonging to the group. Here, one group may include up to six users, and if each bit of the bitmap is set to ‘1’, it indicates that the corresponding user equipment is the user (that is, user allocated with resources) scheduled at a current frame.

Referring to FIG. 1, it is noted that first, second, fourth and sixth users are scheduled at a frame ‘n’ and the other user equipments except for the second user equipment are scheduled at a frame ‘n+p’. Here, each user equipment may acquire location information indicating its location within a user bitmap from the base station when it is added to the group. A resource allocation bitmap represents resource allocation information of scheduled users, wherein the resource allocation information may include a modulation and coding scheme (MCS) and information on size of allocated resource.

In FIG. 1, information on one user equipment may be represented by 3 bits, and since a total of four user equipments are scheduled at the nth frame (Frame n), the size of the resource allocation bitmap becomes 12 bits (3×4). Since a total of five user equipments are scheduled at the (n+p)th frame (Frame n+p), 15-bit sized resource allocation bitmap is formed. Here, the resource allocation bitmap includes MCS information of the scheduled user equipment and allocated resource allocation size information (for example, the number of LRUs).

When the user equipment is added to the group, the base station allocates a user bitmap index, which is used in the user bitmap of the group, to the user equipment. Here, the size of the user bitmap may be fixed or variable in the corresponding group. In other words, the user bitmap may be divided into a fixed user bitmap having a fixed size and a variable user bitmap having a variable size.

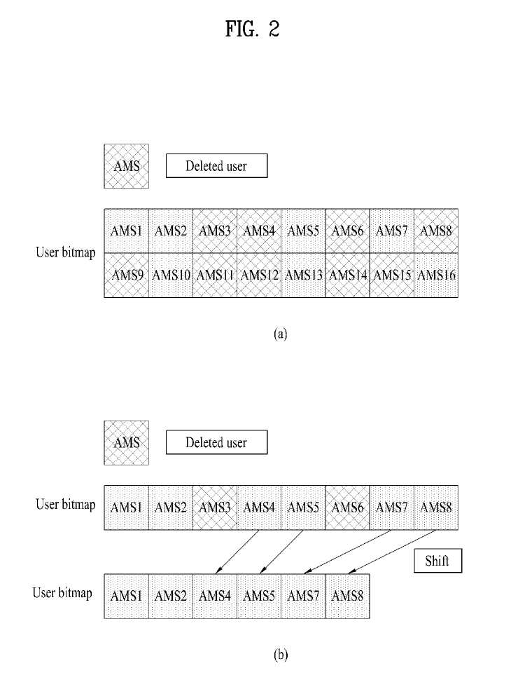

FIG. 2 is a diagram illustrating an example of a fixed user bitmap and a variable user bitmap.

FIG. 2(a) illustrates a fixed user bitmap. The deleted user equipments AMS are the user equipments displayed by a lattice type hatching. The size of the fixed user bitmap remains unchanged even though the user equipments are deleted from the corresponding group, and bitmap indexes of the user equipments, which are not deleted, are not shifted.

FIG. 2(b) illustrates a variable user bitmap. The variable user bitmap is reconfigured to reduce the size of the user bitmap whenever the user equipments AMS belonging to the corresponding group are deleted. In other words, the variable user bitmap is reconfigured as a bitmap for user equipments except for the deleted user equipments. When the user equipments are deleted, the user equipments which are not deleted may identify the deleted user equipments. If the user equipment decides that its user bitmap index should be shifted, it shifts its user bitmap index.

In case of the fixed user bitmap, if the user bitmap is configured to have a great size on the network, unexpected resource waste may occur. For example, if there do not exist a lot of user equipments which belong to the corresponding group, i.e., if many empty spaces exist in the user bitmap, waste of the user bitmap may be caused, whereby unnecessary map overhead may be caused.

Also, if the user bitmap size is too small, as the user bitmap is saturated when the user equipment is added to the group, the user equipment cannot be managed any more. For this reason, a problem may occur in that the number of groups managed by the base station is increased.

In case of the variable user bitmap, the user equipments which belong to the group should reconfigure their user bitmap index as shown in FIG. 2(b) whenever the user equipment is deleted from the group. In order that the base station and the user equipment have the same bitmap index information, the base station should identify whether information (i.e., GRA A-MAP IE) related to the deleted user equipment has been received well, whenever the user equipment is deleted from the group. In other words, a MAP error handling procedure such as MAP NACK channel allocation should be performed considering that the user equipment does not have the GRA A-MAP IE. This may complicate implementation of the user equipment. Accordingly, methods for efficiently reconfiguring a user bitmap will be described hereinafter.

Group control information is used to configure and allocate resources for one or more users (or user equipments) within one user group. Two types of operations are required for group scheduling.

First of all, the base station may perform an operation for allocating one user to one group. In order to add one user to one group in a downlink or uplink, the base station transmits group configuration MAC management message, group configuration A-MAP information element (IE) or group configuration MAC control message to the user equipment.

Next, the base station may allocate resources to users within one group. In order to allocate resources to one or more users within one group, the base station transmits downlink/uplink group resource allocation (GRA) A-MAP IE to the user equipment.

The downlink/uplink group resource allocation (GRA) A-MAP IE is included in user-specific resource assignment information of an A-MAP region. The group resource allocation A-MAP IE includes a bitmap representing scheduled users or signaling resource allocation, modulation and coding scheme (MCS) and/or resource size.

The following Table 1 illustrates an example of a group resource allocation (GRA) A-MAP IE format.

TABLE 1

| Syntax | Size | Contents |
|---|---|---|
| A-MAP IE Type | 4 | DL/UL Group resource allocation A-MAP IE |
| Resource Offset | [6] [8] | Indication of start UR for resource |
| | | allocation to a corresponding group |
| ACK channel offset | TBD | Indication of start point of ACK index used |
| | | for scheduled user equipment at a current |
| | | frame of a corresponding group. |
| NDA | [2] [3] | Indication of the number of AMS deleted |
| | | from a corresponding group |
| For (i=0, i++, i<NDA){ | | |
| User Bitmap index | [5] | Indication of user bitmap index of deleted |
| | | AMS |
| } | | |
| User Bitmap Size | [2] [5] | Indication of length of a user bitmap |
| User Bitmap | variable | Indication of user equipment scheduled |
| | | from a corresponding group. The user |
| | | bitmap size is the same as that indicated by |
| | | a user bitmap size. |
| If (Group MIMO mode set == | | |
| 0b01 or 0b11){ | | |
| MIMO Bitmap | Variable | Indication of MIMO mode for corresponding |
| | | scheduled user equipment |
| } | | |
| If (Group MIMO mode set == | | |
| 0b11){ | | |
| PSI Bitmap | Variable | Bitmap indicating PSI for MU-MIMO |
| Pairing Bitmap | Variable | Bitmap indicating AMS pairs sharing the |
| | | same resource for MU-MIMO |
| } | | |
| Resource Assignment | Variable | Bitmap indicating MCS/resource size for |
| Bitmap | | each scheduled user (AMS). |
| Padding | Variable | Padding bit for byte alignment |
| MCRC | [16] | CRC masked 16 bits |

Description of corresponding fields in Table 1 will be understood with reference to contents of Table 1.

II Method for Reconfiguring Semi-Static User Bitmap

The present invention discloses a method for reconfiguring a size of a user bitmap semi-statically (or semi-dynamically). The base station and the user equipment may maintain the user bitmap semi-statically (or semi-dynamically). For example, the base station may define and use the size of the user bitmap as 4, 8, 16, and 32 bits. In this case, the base station does not reduce the size of the user bitmap whenever the user equipment is deleted but reduce the size of the user bitmap only if the number of users belonging to the group is reduced from 17 to 16, from 9 to 8, and from 5 to 4 and may notify the user equipment of information on the shift of the bitmap size.

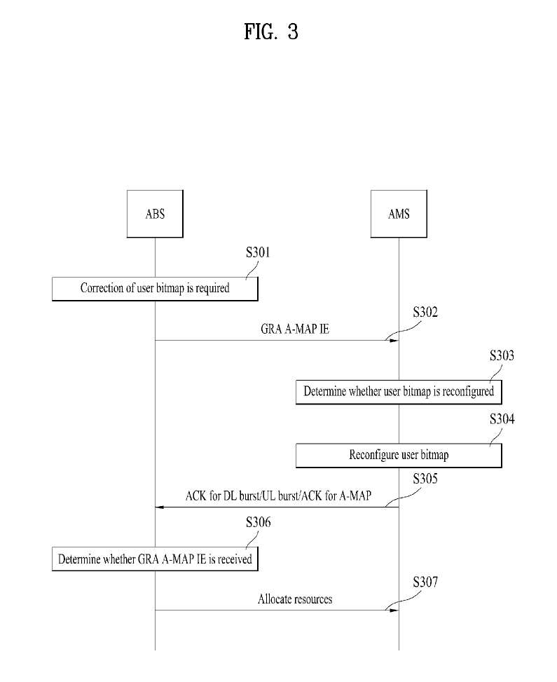

FIG. 3 is a diagram illustrating one of methods for reconfiguring a bitmap in accordance with the embodiment of the present invention.

The base station may determine whether the size of the user bitmap should be corrected if there is any enter and exit of the user in the group managed by the base station. For example, the base station may recognize that shift of the user bitmap index is required (S301).

In this case, the base station transmits the group resource allocation A-MAP information element (GRA A-MAP IE), which includes a user bitmap status bitmap (UBSB) and a shifting indicator field set to ‘1’, to the user equipments belonging to the group (S302).

The following Table 2 illustrates an example of a GRA A-MAP IE format used at the step S302.

TABLE 2

| Syntax | Size | Contents |
|---|---|---|
| A-MAP IE Type | | DL GRA A-MAP IE |
| HFA | | Indication of start of ACK index used for all |
| | | the user equipments belonging to a |
| | | corresponding group at a current frame. |
| NDA | | Indication of the number of user |
| | | equipments deleted from a corresponding |
| | | group. |
| | | 0b00: 0, |
| | | 0b01: 1, |
| | | 0b10: 2, |
| | | 0b11: 3 |
| For (i=0, i++, i<NDA){ | | |
| User Bitmap Index | | Indication of user bitmap index of deleted |
| | | user equipments. |
| } | | |
| User Bitmap size | | If a shifting indicator is set to ‘1’ and a |
| | | retransmission flag is set to ‘0’, the user |
| | | bitmap size indicates a length of a user |
| | | bitmap status bitmap. If not so, the user |
| | | bitmap size indicates a length of a user bitmap. |
| | | 0b00: 0, |
| | | 0b01: 4, |
| | | 0b10: 8, |
| | | 0b11: 16 |
| Shifting indicator | 1 | Indication whether a user bitmap should be |
| | | reconfigured and a current A-MAP includes |
| | | UBSB. |
| | | 0b1: the user bitmap should be |
| | | reconfigured and the current A-MAP |
| | | includes UBSB. |
| | | 0b0: reserved |
| If (shifting indicator == 1) | | |
| { | | |
| Retransmission Flag | 1 | Indication whether a current A-MAP is |
| | | retransmission. |
| | | 0b0: transmission of A-MAP for UBSB is |
| | | initial transmission. |
| | | 0b1: transmission of the current A-MAP is |
| | | retransmission. |
| If (Retransmission Flag == | | |
| 1){ | | |
| UBSB size | TBD | Included only if a retransmission flag is set |
| | | to 1. It indicates a size of UBSB. If the |
| | | retransmission flag is set to 1, the size of |
| | | UBSB is set to the same value as that of |
| | | previous USBS. |
| User Bitmap Status | Variable | It indicates scheduled user equipment AMS |
| Bitmap | | and non-scheduled user equipment, which |
| | | belong to a corresponding group. The size |
| | | of UBSB is the same as that indicated by a |
| | | UBSB size field. If the retransmission flag is |
| | | set to 1, UBSB includes a structure of a |
| | | previous user bitmap. |
| ReTx Bitmap | Variable | Retransmission(ReTx) bitmap field is |
| | | included only if the retransmission flag is |
| | | set to ‘1’. The retransmission bitmap field |
| | | indicates a user equipment that should shift |
| | | a user bitmap at a current frame. The size |
| | | of the retransmission bitmap indicates the |
| | | number of user equipments which should |
| | | shift the user bitmap indicated by UBSB. |
| }else | | |
| User Bitmap Status | Variable | It indicates scheduled AMS and non- |
| Bitmap | | scheduled AMS, which belong to a |
| | | corresponding group. |
| } | | |
| User Bitmap | Variable | It indicates AMS scheduled from a |
| | | corresponding group. If a shifting indicator |
| | | is set to ‘1’ and a retransmission flag is set |
| | | to ‘0’, the size of a user bitmap is set to the |
| | | same value as the number of bits set to ‘1’ |
| | | of USBS. |
| — | — | — |
| Padding | Variable | Padding bit for byte alignment |
| MCRC | [16] | CRC masked 16 bits |

Referring to Table 2, the GRA A-MAP IE may include a HARQ feedback allocation (HFA) indicating a start of ACK index used for all the users (i.e., AMS) belonging to the corresponding group at the current subframe, a number of deletion AMS (NDA) field indicating the number of user equipments deleted from the corresponding group, a user bitmap index field indicating a user bitmap index of the deleted user equipments (AMS), and a user bitmap size field indicating a length of a user bitmap status bitmap (UBSB) if a shifting indicator is set to ‘1’ and a retransmission flag is set to ‘0’ and indicating a length of the user bitmap if not so.

Also, the GRA A-MAP IE may include a shifting indicator field indicating whether the user bitmap should be reconfigured and the current A-MAP includes the UBSB. If the shifting indicator field is set to ‘1’, the GRA A-MAP IE may include a retransmission flag indicating whether the current A-MAP is retransmission.

Also, if the retransmission is set to ‘1’, the GRA A-MAP IE may further include a UBSB size field indicating the size of the UBSB, a UBSB field indicating scheduled user equipments and non-scheduled user equipments, which belong to the corresponding group, and a retransmission bitmap field indicating a user equipment that should shift the user bitmap at the current frame. Here, the size of the retransmission bitmap field may indicate the number of user equipments that should shift the user bitmap indicated by the UBSB.

In Table 2, if each bit of the UBSB is set to ‘0’, it indicates deleted users or a resource hole corresponding to a resource which is not used. If each bit of the UBSB is set to ‘1’, it indicates scheduled user equipments or non-scheduled user equipments, which belong to the corresponding group.

In Table 2, the user bitmap field indicates AMS scheduled from the corresponding group. If the shifting indicator is set to ‘1’ and the retransmission flag is set to ‘0’, the size of the user bitmap is set to the same value as the number of bits set to ‘1’ of the UBSB.

Referring to FIG. 3 again, the base station allocates HARQ feedback allocation (HFA) channel for the GRA A-MAP IE to the corresponding user equipments that are not scheduled at the corresponding time but need shift of the user bitmap index (not shown).

At the step S302, the user equipment (AMS) may acquire various kinds of information included in the GRA A-MAP IE by receiving the GRA A-MAP IE. If the user equipment receives information (for example, UBSB, shifting indicator, etc.) on user bitmap reconfiguration, it may determine whether to reconfigure its user bitmap index by comparing the received information with its user bitmap index information (S303).

If the user equipment determines to reconfigure its user bitmap, it may reconfigure the user bitmap by calculating where to shift its user bitmap index, on the basis of information (e.g., UBSB) included in the GRA A-MAP IE (S304).

For example, it is assumed that the user equipment receives the GRA A-MAP IE of which shifting indicator field is set to ‘1’ and the retransmission flag is set to ‘1’ at the step S302. Here, if the user equipment receives the GRA A-MAP IE, which is initially transmitted and includes the UBSB, it disregards the UBSB included in the GRA A-MAP IE. If the user equipment receives the retransmitted GRA A-MAP IE that includes the UBSB, it may reconfigure its user bitmap index by using the corresponding UBSB field.

If the user equipment that should reconfigure the user bitmap is not scheduled at the corresponding time, it transmits ACK message to the base station through the HARQ feedback allocation channel for the GRA A-MAP IE allocated thereto.

The base station may identify whether the GRA A-MAP IE transmitted at the step S302 has been normally transmitted to the user equipment by receiving ACK for downlink (DL) data burst, uplink (UL) data burst or ACK signal for the GRA A-MAP from the user equipment (S305).

For example, if the base station receives ACK for the GRA A-MAP, ACK for the DL data burst or UL data burst from the user equipment that should reconfigure the user bitmap, it may determine that the corresponding user equipment has received the GRA A-MAP IE well. Also, if the base station does not receive the ACK for the GRA A-MAP, the ACK for the DL data burst or UL data burst from the user equipment that should reconfigure the user bitmap, it may determine that the corresponding user equipment has not received the GRA A-MAP IE for user bitmap reconfiguration, and may perform an error processing procedure for processing the determined result (S306).

The base station does not allocate any resource to the corresponding user equipment until the user equipment normally receives information for user bitmap reconfiguration. If the base station determines that the user equipment has normally received the GRA A-MAP at the step S306, it allocates a group resource to the corresponding user equipment (S307).

Hereinafter, the error processing procedure performed by the base station at the step S306 will be described.

Preferably, the base station ABS exactly knows whether the GRA A-MAP IE has been successfully received in the user equipment that belongs to the corresponding group and should reconfigure the user bitmap. Here, if the scheduled user equipment reconfigures the user bitmap, the base station may know whether the user equipment has successfully received the GRA A-MAP by detecting (or decoding) the power of DL ACK for downlink burst or uplink HARQ burst.

If the non-scheduled user equipment reconfigures the user bitmap, since the base station does not know whether the corresponding user equipment has normally received the A-MAP, it is preferable that the base station allocates HARQ ACK channel for the GRA A-MAP IE to the corresponding user equipment. In other words, the base station may perform error processing by identifying whether ACK signal is transmitted to the non-scheduled user equipment through the allocated ACK channel.

The base station allocates the ACK channel for the scheduled user equipment, which will shift the user bitmap index, after allocating HARQ feedback allocation (HFA) channel (i.e., ACK channel) for the deleted user equipment. The order of allocation of the ACK channels may be changed. For example, after the HFA channel of the scheduled user equipments is allocated, the HFA channel for the deleted AMSs is allocated, and the HFA channel of the user equipments, which reconfigure the user bitmap, is allocated.

If there is no deleted user equipment in the corresponding group and there are scheduled user equipments and shifting user equipments therein, the HFA channel for the scheduled user equipments and the HFA channel for the shifting user equipments may be allocated. It is preferable that the base station does not allocate the HFA for the scheduled user equipments in case of GRA A-MAP IE for an uplink.

If there is no deleted user equipment, user equipment for reconfiguring the user bitmap or scheduled user equipment, HARQ feedback allocation channel for each AMS is not allocated. In case of the GRA A-MAP IE for an uplink, it is preferable that the HARQ feedback allocation channel for the scheduled AMS is not allocated.

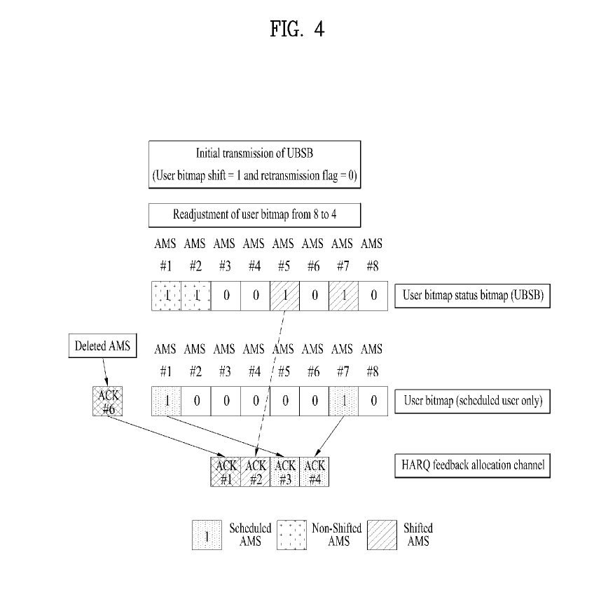

FIG. 4 is a diagram illustrating one of methods for reconfiguring a bitmap if UBSB is initially transmitted in accordance with the embodiment of the present invention.

FIG. 4 illustrates that the user equipment reconfigures the user bitmap through signaling as shown in FIG. 3 if eight users AMS exist in one group. For example, it is assumed that the shifting indicator is set to ‘1’ and the retransmission flag is set to ‘0’ at the step S302.

The user bitmap status bitmap (UBSB) represents scheduled user equipments or non-scheduled user equipments in the corresponding group. In other words, the bitmap of the UBSB, which is set to ‘0’, represents the deleted user equipments or a resource hole. The bitmap of the UBSB, which is set to ‘1’, represents the scheduled user equipments or the non-scheduled user equipments. Here, in the corresponding group, AMS #1, #2, #5 and #7 represent the scheduled user equipments or the non-scheduled user equipments, and AMS #1 and #7 of which user bitmap is set to 1 represent the scheduled user equipments AMS.

FIG. 4 illustrates that the size of the user bitmap is reduced from 8 to 4. At this time, the user equipment AMS #6 is deleted. The users belonging to the corresponding group may know that the user equipments AMS #1, #2 #5 and #7 are scheduled or not scheduled in the current group through the UBSB, and may know that the corresponding user equipments (i.e., AMS #5 and AMS #7) should be shifted if shift of the user occurs (shifting indicator=1).

Each of the users may know that the deleted user equipment at the current time is the AMS #6 by identifying the NDA field (or deletion bitmap or deletion index). Also, each of the users may know information on scheduled user equipments at the current time, through the user bitmap. The user equipment may know the location of the HARQ feedback allocation (HFA) channel allocated thereto, through each bitmap.

If the HFA channel for the deleted user equipments is first allocated, in the allocation order of the HFA channels, the AMS #6 occupies the first location (ACK #1) in the GRA HFA, the AMS #5 shifted without no scheduling occupies the second location (ACK #2), and the other scheduled user equipments (AMS #1 and AMS #7) occupy the third and fourth locations (ACK #3 and ACK #4).

Since the non-scheduled user equipment cannot transmit UL ACK for uplink data or downlink data, it is preferable that the base station allocates a separate ACK channel to the non-scheduled user equipment in the same manner as the deleted user equipment.

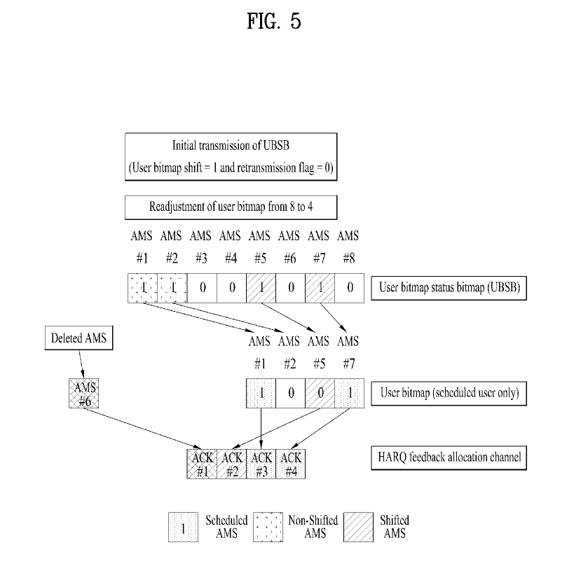

FIG. 5 is a diagram illustrating a user bitmap reconfigured in FIG. 4 in accordance with the embodiment of the present invention.

The base station and the user equipment may use the user bitmap reconfigured in accordance with the method described in FIG. 4. In other words, the base station may transmit the GRA A-MAP IE, which includes the user bitmap of 4 bits reconfigured as shown in FIG. 5, to the user equipments.

Also, even when shifting in the bitmap first occurs (shifting indicator=1, retransmission flag=0), the size applied after shifting may be the size of the user bitmap. In this example, since the size of the user bitmap is changed from 8 bits to 4 bits, the size of the user bitmap will be 4 at the corresponding time.

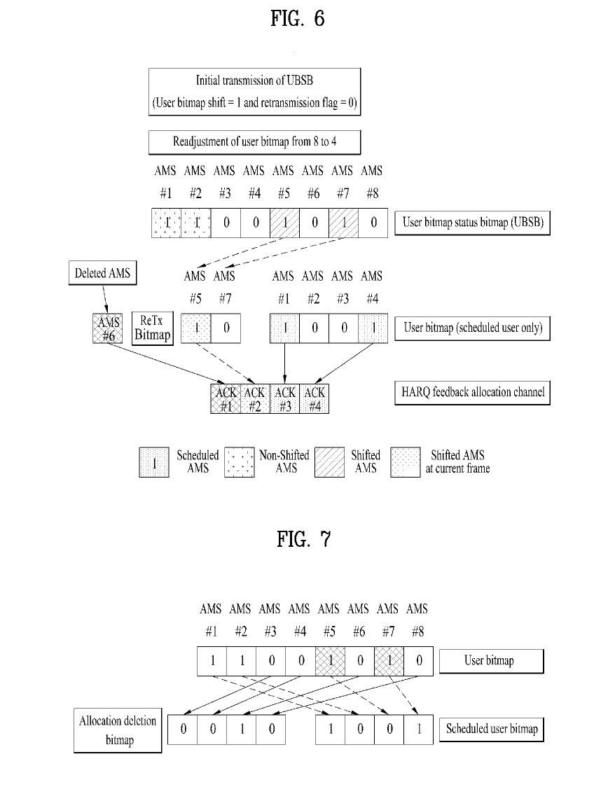

FIG. 6 is a diagram illustrating another one of methods for reconfiguring a bitmap if a UBSB is retransmitted in accordance with the embodiment of the present invention.

The base station transmits the GRA A-MAP IE, which includes information (e.g., user bitmap) related to the HARQ feedback allocation channel, to the user equipments. Here, if the base station does not receive ACK (e.g., ACK for DL data burst or ACK for GRA A-MAP IE) for the GRA A-MAP IE from the shifting user equipment, it may again transmit the GRA A-MAP IE of which retransmission flag is set to ‘1’, to the user equipments.

In FIG. 6, it is assumed that the base station does not receive ACK signal from the user equipment AMS #5. The size of the UBSB included in the GRA A-MAP IE retransmitted from the base station is 8 bits, and the size of the user bitmap is 4 bits. The size of the retransmission (ReTx) bitmap is configured by the number of shifting user equipments AMS #5 and AMS #7 in the UBSB. Here, since the base station has not received the ACK for the user equipment AMS #5, it sets the corresponding bit to 1. The HFA channels of the respective user equipments are allocated in the order of the deleted user equipments, the shifting user equipments and the scheduled user equipments.

III. Method 1 for Reconfiguring a User Bitmap by Using a Deletion Bitmap

When the user equipments are deleted from a group, the base station may represent the deleted user equipments in a bitmap type (e.g., deletion bitmap). In this case, the size of the deletion bitmap may be determined as the size of the bit set to ‘1’ in the user bitmap. Here, if the deletion bitmap is used, it is preferable that the UBSB includes information on the deleted user equipments, if any, as well as the user equipments constituting the group. In other words, the UBSB may be configured by scheduled user equipments AMS and non-scheduled user equipments AMS. The user equipment may calculate the size of the user bitmap when receiving the GRA A-MAP IE from the base station by considering values N and M transferred as group resource configuration MAC control messages.

Hereinafter, DL/UL GRA A-MAP IE used in the embodiment of the present invention will be described. The following Table 3 illustrates an example of a downlink GRA A-MAP IE format.

TABLE 3

| Syntax | Size | Contents |
|---|---|---|
| DL GRA A-MAP IE ( ) { | | |
| A-MAP Type | 4 | DL GRA A-MAP IE |
| Resource offset | [6] [8] | Indication of start LRU for resource |
| | | allocation to a corresponding group. |
| ACK channel offset | TBD | Indication of scheduled AMS, deleted AMS, |
| | | or shifted AMS at a current subframe of a |
| | | corresponding group. |
| Shifting indicator | 1 | It indicates whether it includes a user |
| | | bitmap and whether the user bitmap should |
| | | be reconfigured. |
| | | 0b0: |
| | | 0b1: the user bitmap should be |
| | | reconfigured. |
| User Bitmap size | 2 | Indication of a length of a user bitmap. |
| | | If a shifting indicator is set to ‘1’, it indicates |
| | | the length of the user bitmap. If the shifting |
| | | indicator is set to ‘0’, it indicates a length of |
| | | a scheduled user bitmap. |
| | | 0b00: 4, |
| | | 0b01: 8, |
| | | 0b10: 12, |
| | | 0b11: 16 |
| If (shifting indicator == 1) | | |
| { | | |
| Retransmission Flag | 1 | Indication as to whether a user bitmap is |
| | | retransmitted. |
| | | 0b0: user bitmap transmission for shifted |
| | | AMS is initial transmission. |
| | | 0b1: current user bitmap transmission is |
| | | retransmission. |
| User Bitmap | Variable | It indicates scheduled user equipment AMS |
| | | and non-scheduled user equipment, which |
| | | belong to a corresponding group. If the |
| | | retransmission flag is set to ‘1’, the user |
| | | bitmap may include a structure of a |
| | | previous user bitmap. |
| If (Retransmission Flag ==1){ | | |
| ReTx Bitmap | Variable | Retransmission(ReTx) bitmap field is |
| | | included only if the retransmission flag is |
| | | set to ‘1’. The retransmission bitmap field |
| | | indicates a user equipment that should shift |
| | | a user bitmap at a current frame, among |
| | | user equipments indicated by the UBSB. |
| | | The size of the ReTx bitmap is the same as |
| | | the number of AMS which should shift the |
| | | user bitmap index in the UBSB. |
| } | | |
| } | | |
| Scheduled User Bitmap | Variable | Bitmap indicating scheduled user in a |
| | | corresponding group. If a shifting indicator |
| | | is set to ‘0’, the size of the scheduled user |
| | | bitmap is the same as that of the user |
| | | bitmap. If the shifting indicator is set to ‘1’, |
| | | the size of the scheduled user bitmap is the |
| | | same as the number of bits set to ‘1’ in the |
| | | user bitmap. |
| | | If the shifting indicator is ‘1’ and the |
| | | retransmission flag is ‘1’, and if the size of |
| | | the user bitmap is N * m (m, . . . {1, 2, . . . , M}), |
| | | the size of the scheduled bitmap is N * (m − 1). |
| Deletion indicator | 1 | It indicates whether there is a user |
| | | equipment deleted in a corresponding |
| | | group. |
| If (Deletion indicator == 1) | | |
| { | | |
| Deletion Bitmap | Variable | If the shifting indicator is set to ‘1’ and the |
| | | retransmission flag is set to ‘0’, the size of |
| | | the deletion bitmap is the same as the |
| | | number of 0 in the user bitmap. If not so, |
| | | the size of the deletion bitmap is the same |
| | | as the number of ‘0’ of the scheduled user |
| | | bitmap or the number of ‘1’ of the |
| | | scheduled user bitmap. |
| } | | |
| If (Group MIMO mode set == | | |
| 0b01 or 0b10) { | | |
| MIMO bitmap | Variable | Bitmap indicating MIMO mode for |
| | | scheduled AMS. |
| } | | |
| If (Group MIMO mode set == | | |
| 0b11) { | | |
| PSI bitmap | Variable | It indicates PSI for MU-MIMO. |
| Pairing bitmap | Variable | It indicates a pair of AMS that share the |
| | | same resource for MU-MIMO. |
| } | | |
| Resource Assignment | Variable | It indicates size of resource/MCS for each |
| Bitmap | | scheduled user (AMS). |
| Padding | Variable | Padding bit for byte alignment |
| MCRC | [16] | CRC masked 16 bits |

Referring to Table 3, the DL GRA A-MAP IE may include a resource offset field indicating a start LRU for resources allocated to the corresponding group, ACK channel offset field indicating scheduled AMS, deleted AMS, or shifted AMS at the current subframe of the corresponding group, a shifting indicator field indicating whether it includes a user bitmap and whether the user bitmap should be reconfigured, and a user bitmap size field indicating a size of the user bitmap. Here, the user bitmap size field indicates the length of the user bitmap if the shifting indicator field is set to ‘1’ and indicates the length of the scheduled user bitmap if the shifting indicator field is set to ‘0’.

If the shifting indicator is set to ‘1’, the DL GRA A-MAP IE may further include a retransmission flag field indicating whether the user bitmap is retransmitted or initially transmitted, and a user bitmap field indicating scheduled AMS and non-scheduled AMS, which belong to the corresponding group. Here, if the user bitmap field is set to ‘1’, it indicates the scheduled AMS or the non-scheduled AMS, and if the user bitmap field is set to ‘0, it indicates a bitmap index, which is not used, or deleted AMS.

If the retransmission flag is set to ‘1’, the DL GRA A-MAP IE may further include a retransmission (ReTx) bitmap field indicating a user equipment that needs shift of the user bitmap, among user equipments indicated by the UBSB, at the current frame. Here, the size of the ReTx bitmap is the same as the number of AMS which will shift the user bitmap index in the UBSB.

The DL GRA A-MAP IE of Table 3 may further include a scheduled user bitmap indicating users scheduled in the corresponding group. Here, if the shifting indicator is set to ‘0’, the size of the scheduled user bitmap is the same as that of the user bitmap, and if the shifting indicator is set to ‘1’, the size of the scheduled user bitmap is the same as the number of bits set to ‘1’ in the user bitmap. If the shifting indicator is ‘1’ and the retransmission flag is ‘1’, and if the size of the user bitmap is N*m (m {1, 2, . . . , M}), the size of the scheduled bitmap is N*(m-1). For example, if four types of sizes exist for the user bitmap and the size of the user bitmap is 16, the size of the scheduled user bitmap is 12.

Also, the DL GRA A-MAP IE of Table 3 may further include a deletion indicator indicating whether deleted user equipments exist in a corresponding group. If the deletion indicator is set to ‘1’, the DL GRA A-MAP IE may further include a deletion bitmap indicating deleted users. Here, if the shifting indicator is set to ‘1’ and the retransmission flag is set to ‘0’, the size of the deletion bitmap is the same as the number of ‘0’ in the user bitmap. If not so, the size of the deletion bitmap is the same as the number of ‘0’ of the scheduled user bitmap or the number of ‘1’ of the scheduled user bitmap.

The base station ABS may store previous user bitmap information until the user equipments AMSs that should reconfigure the user bitmap receive the UBSB successfully. In Table 3, the user bitmap size field may have a semi-static (or semi-dynamically) value.

N represents the user bitmap size, and M represents the number of the user bitmap sizes. N and M may be transmitted to the user equipments through group configuration MAC control message or additional broadcast information message. The user bitmap size field has values of (N*1), (N*2), . . . , (N*M). For example, if N is 4 and M is 4, the user bitmap size field has values of 4(N*1), 8(N*2), 12(N*3), and 16(N*4(M)). In this case, it is preferable that the length of the user bitmap size field is 2 bits.

The following Table 4 illustrates an example of an uplink GRA A-MAP IE format.

TABLE 4

| Syntax | Size | Contents |
|---|---|---|
| DL GRA A-MAP IE ( ) { | | |
| A-MAP Type | 4 | DL GRA A-MAP IE |
| Resource offset | [6] [8] | Indication of start LRU for resource |
| | | allocation to a corresponding group. |
| ACK channel offset | TBD | Indication of scheduled AMS, deleted AMS, |
| | | or shifted AMS at a current subframe of a |
| | | corresponding group. |
| Shifting indicator | 1 | It indicates whether it includes a user |
| | | bitmap and whether the user bitmap should |
| | | be reconfigured. |
| | | 0b0: |
| | | 0b1: the user bitmap should be |
| | | reconfigured. |
| User Bitmap size | 2 | Indication of a length of a user bitmap. |
| | | If a shifting indicator is set to ‘1’, it indicates |
| | | the length of the user bitmap. If the shifting |
| | | indicator is set to ‘0’, it indicates a length of |
| | | a scheduled user bitmap. |
| | | 0b00: 4, |
| | | 0b01: 8, |
| | | 0b10: 12, |
| | | 0b11: 16 |
| If (shifting indicator == 1) | | |
| { | | |
| Retransmission Flag | 1 | Indication as to whether a user bitmap is |
| | | retransmitted. |
| | | 0b0: user bitmap transmission for shifted |
| | | AMS is initial transmission. |
| | | 0b1: current user bitmap transmission is |
| | | retransmission. |
| A-MAP HFA Index | | It indicates a start of ACK channel index |
| | | used for shifted user equipment at a current |
| | | subframe of a corresponding group |
| User Bitmap | Variable | It indicates scheduled AMS and non- |
| | | scheduled AMS, which belong to a |
| | | corresponding group. If the retransmission |
| | | flag is set to ‘1’, the user bitmap may |
| | | include a structure of a previous user |
| | | bitmap. |
| If (Retransmission Flag ==1){ | | |
| ReTx Bitmap | Variable | Retransmission(ReTx) bitmap field is |
| | | included only if the retransmission flag is |
| | | set to ‘1’. The retransmission bitmap field |
| | | indicates a user equipment that should shift |
| | | a user bitmap at a current frame, among |
| | | user equipments indicated by the UBSB. |
| | | The size of the ReTx bitmap is the same as |
| | | the number of AMS which will shift the user |
| | | bitmap index in the UBSB. |
| } | | |
| } | | |
| Scheduled User Bitmap | Variable | Bitmap indicating scheduled user in a |
| | | corresponding group. If a shifting indicator |
| | | is set to ‘0’, the size of the scheduled user |
| | | bitmap is the same as that of the user |
| | | bitmap. If the shifting indicator is set to ‘1’, |
| | | the size of the scheduled user bitmap is the |
| | | same as the number of bits set to ‘1’ in the |
| | | user bitmap. |
| | | If the shifting indicator is ‘1’ and the |
| | | retransmission flag is ‘1’, and if the size of |
| | | the user bitmap is N * m (m, . . . {1, 2, . . . , M}), |
| | | the size of the scheduled bitmap is N * (m − 1). |
| Deletion indicator | 1 | It indicates whether there is adeleted user |
| | | equipment in a corresponding group. |
| If (Deletion indicator == 1) | | |
| { | | |
| Deletion Bitmap | Variable | If the shifting indicator is set to ‘1’ and the |
| | | retransmission flag is set to ‘0’, the size of |
| | | the deletion bitmap is the same as the |
| | | number of 0 in the user bitmap. If not so, |
| | | the size of the deletion bitmap is the same |
| | | as the number of ‘0’ of the scheduled user |
| | | bitmap or the number of ‘1’ of the |
| | | scheduled user bitmap. |
| } | | |
| If (Group MIMO mode set == | | |
| 0b01 or 0b10) { | | |
| MIMO bitmap | Variable | Bitmap indicating MIMO mode for |
| | | scheduled AMS. |
| } | | |
| If (Group MIMO mode set == | | |
| 0b11) { | | |
| PSI bitmap | Variable | It indicates PSI for MU-MIMO. |
| Pairing bitmap | Variable | It indicates a pair of AMS that share the |
| | | same resource for MU-MIMO. |
| } | | |
| Resource Assignment | Variable | It indicates size of resource/MCS for each |
| Bitmap | | scheduled user equipment AMS. |
| Padding | Variable | Padding bit for byte alignment |
| MCRC | [16] | CRC masked 16 bits |

The description of the respective fields in Table 4 will be understood with reference to the description of Table 4 and Table 3. However, Table 4 may further include an A-MAP HFA index (A-MAP HFA index) field as the GRA A-MAP IE used in case of the uplink. The A-MAP HFA index field indicates a start of ACK channel index used for the user equipment which is shifted at the current frame of the corresponding group.

The DL/UL GRA A-MAP IE of Table 3 and Table 4 may be used at the step S302 of FIG. 3. In this case, the AMS determines whether reconfiguration of the user bitmap is required. If the user bitmap should be reconfigured, the user equipment may reconfigure the user bitmap using the information included in Table 3 and Table 4. The other procedure will be understood with reference to FIG. 3. Hereinafter, methods for reconfiguring a user bitmap index of a corresponding group in a base station and user equipments AMS will be described.

FIG. 7 is a diagram illustrating an example of an initial user bitmap used together with a deletion bitmap in accordance with the embodiment of the present invention.

The base station ABS may reconfigure the user bitmap index of a plurality of users AMSs at a frame (or subframe). In order to reconfigure the user bitmap index in a corresponding group, the base station may include a user bitmap of FIG. 7 in the GRA A-MAP IE. Here, the GRA A-MAP IE may be understood with reference to FIG. 3 to FIG. 4.

In the user bitmap, ‘1’ represents scheduled AMS or non-scheduled AMS in the corresponding group, and ‘0’ represents AMS which is not used or deleted AMS. If the shifting indicator is set to ‘1’ and the retransmission flag is set to ‘0’, a release bitmap is configured by ‘0’ of the user bitmap, and the size of the release bitmap is determined in accordance with the number of ‘0’ of the user bitmap.

FIG. 7 illustrates an example of an initial user bitmap for reconfiguring a user bitmap if there are deleted user equipments in the corresponding group. If the user bitmap is retransmitted (that is, retransmission flag=1), the user bitmap has the same structure as that of a previous user bitmap of the corresponding group. Also, the base station may transmit the GRA A-MAP IE, which includes a retransmission (ReTx) bitmap, to notify what user equipment should reconfigure the user bitmap at the corresponding frame (or subframe). If the shifting indicator is set to ‘1’ and the retransmission flag is set to ‘1’, the retransmission bitmap is configured by the number of user equipments (for example, AMS #5 and AMS #7 in FIG. 7) which will be shifted in the user bitmap, and the length of the deletion bitmap is determined in accordance with the number of ‘0’ of the scheduled user bitmap.

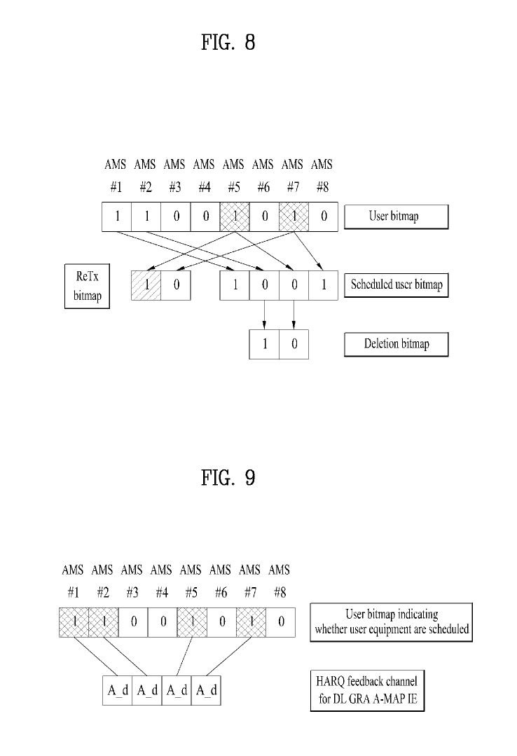

FIG. 8 is a diagram illustrating an example of a retransmitted user bitmap used together with a deletion bitmap in accordance with the embodiment of the present invention.

The user equipments AMSs (users) may know what user equipment should reconfigure a user bitmap index by decoding the GRA A-MAP IE of Table 3 or Table 4 from the base station. If a specific user equipment knows that its user bitmap should be reconfigured, the specific user equipment may reconfigure the user bitmap by using the information included in the GRA A-MAP IE of Table 3 or Table 4. Also, the user equipment may transmit ACK signal to the base station to notify that it has received the GRA A-MAP IE normally.

If the user equipment AMS receives the GRA A-MAP IE, which includes the retransmitted user bitmap (e.g., retransmission flag=1), and if the user equipment does not receive the user bitmap at a previous frame (or subframe), it supposes that the GRA A-MAP IE including the initial user bitmap has not been received normally, and reconfigures the user bitmap by using the information included in the GRA A-MAP IE including the retransmitted user bitmap. The user equipment transmits ACK signal to the base station through the allocated HARQ feedback allocation (HFA) channel.

If the user equipment AMS receives the GRA A-MAP IE, which includes the retransmitted user bitmap, and if the user equipment has normally received the user bitmap at the previous frame (or subframe), it does not have to reconfigure its user bitmap.

If the shifted user equipment is scheduled at the current frame (or subframe), the HARQ feedback allocation channel is not allocated to the shifted user equipment. Also, it is preferable that the shifted user equipment transmits HARQ ACK signal or HARQ NACK signal for DL data burst to the base station instead of HARQ ACK signal or HARQ NACK signal for the GRA A-MAP IE.

FIG. 8 illustrates that the shifting indicator is set to ‘1’ and the retransmission flag is set to ‘1’. The user bitmap represents the scheduled user equipments and the non-scheduled user equipments, and the user equipment may know what user equipments will be shifted, through the user bitmap. If the retransmission bitmap is configured by the number of user equipments that will be shifted in the user bitmap, ‘1’ in the retransmission bitmap represents the user equipments that will be shifted at the current frame, and ‘0 represents the user equipments shifted by previous transmission. The scheduled user bitmap represents what user equipments will be scheduled at the current frame, and the corresponding bit is set to ‘1’, and the deletion bitmap is configured as much as the number of ‘0’ in the scheduled user bitmap.

IV. Method 2 for Reconfiguring a User Bitmap Using a Deletion Bitmap

Hereinafter, another embodiment of the method for reconfiguring a user bitmap using a deletion bitmap, which is described in III, will be described. The following Table 5 illustrates an example of a GRA A-MAP IE format used in this IV.

TABLE 5

| Syntax | Size | Contents |
|---|---|---|
| GRA A-MAP IE ( ) { | | |
| A-MAP IE Type | 4 | GRA A-MAP IE |
| HARQ Feedback Index | 4 | Indication of start of HARQ feedback |
| | | channel for a corresponding group. |
| Long TTI Length | 1 | |
| Deletion indicator | 1 | It indicates whether a user bitmap should |
| | | be reconfigured or whether deleted user |
| | | exists. |
| | | 0b0: no deleted user, |
| | | 0b1: deleted user exists. |
| User Bitmap size | Variable | Indication of a length of a user bitmap. |
| | | 0b00: 4, |
| | | 0b01: 8, |
| | | 0b10: 12, |
| | | 0b11: 16 |
| If (deletion indicator == 1) | | |
| { | | |
| Shifting indicator | 1 | It indicates whether the user bitmap should |
| | | be reconfigured or there exists a deleted |
| | | user. |
| | | 0b0: user bitmap reconfiguration is not |
| | | required, |
| | | 0b1: the user bitmap is reconfigured. |
| If (shifting indicator == 1) | | |
| { | | |
| User Bitmap | Variable | It indicates scheduled user equipments and |
| | | non-scheduled user equipments, which |
| | | belong to a corresponding group. If each bit |
| | | is set to ‘1’, it indicates scheduled user |
| | | equipment or non-scheduled user |
| | | equipment. If each bit is set to ‘0’, it |
| | | indicates a resource hole or deleted user |
| | | equipment. |
| Deletion & Resource Hole | Variable | It indicates a deleted user equipment or a |
| Bitmap | | resource hole. The size of this field is the |
| | | same as the number of ‘0’ of the user |
| | | bitmap. If each bit is set to ‘1’, it indicates a |
| | | deleted user equipment. If each bit is set to |
| | | ‘0’, it indicates a resource hole. |
| Scheduled User Bitmap | Variable | It indicates a scheduled user in a |
| | | corresponding group. The size of this field |
| | | is the same as the number of ‘1’ in the user |
| | | bitmap. |
| }else{ | | |
| User Bitmap | Variable | It indicates scheduled user equipments and |
| | | non-scheduled user equipments, which |
| | | belong to a corresponding group. If each bit |
| | | is set to ‘1’, it indicates scheduled user |
| | | equipment or non-scheduled user |
| | | equipment. If each bit is set to ‘0’, it |
| | | indicates a resource hole or deleted user |
| | | equipment. |
| Deletion Bitmap | Variable | It indicates a deleted user equipment. The |
| | | size of this field is the same as the number |
| | | of ‘0’ of the user bitmap. If each bit is set to |
| | | ‘1’, it indicates a deleted user equipment. If |
| | | each bit is set to ‘0’, it indicates a resource |
| | | hole and a non-scheduled user equipment. |
| } | | |
| }else{ | | |
| User Bitmap | Variable | It indicates a scheduled user in a |
| | | corresponding group. If the deletion |
| | | indicator is set to ‘0’, the size of the user |
| | | bitmap depends on the user bitmap size |
| | | field. If the deletion indicator is set to ‘1’, the |
| | | size of the user bitmap is the same as the |
| | | number of 1 in the user bitmap. |
| } | | |
| Resource Offset | 8 | It indicates associated subframe and start |
| | | LRU for resource allocated to a |
| | | corresponding group. |
| If (Group MIMO mode set == | | |
| 0b01 or 0b10) { | | |
| MIMO bitmap | Variable | It indicates MIMO mode for scheduled |
| | | AMS. |
| } | | |
| If (Group MIMO mode set == | | |
| 0b11) { | | |
| PSI bitmap | Variable | It indicates PSI for MU-MIMO. |
| Pairing bitmap | Variable | It indicates a pair of AMS that share the |
| | | same resource for MU-MIMO. |
| } | | |
| Resource Assignment | Variable | It indicates size of resource/MCS for each |
| Bitmap | | scheduled user equipment AMS. |
| Padding | Variable | Padding bit for byte alignment |
| MCRC | [16] | CRC masked 16 bits |

Referring to Table 5, the GRA A-MAP IE may include a field (A-MAP IE Type) indicating a type of a corresponding information element, a field (HARQ Feedback Index) indicating a start of an HARQ feedback channel of a corresponding group, a deletion indicator field indicating whether deleted user equipments exist or a user bitmap should be reconfigured in a corresponding frame, and a user bitmap size field indicating a length of the user bitmap. Here, the user bitmap size field may be determined by Ceil{(log₂(M max))}.

If the deletion indicator field is set to ‘1’, the GRA A-MAP IE may further include a shifting indicator field indicating whether there exists a reconfigured user bitmap or deleted user equipments.

If the shifting indicator field is set to ‘1’, the GRA A-MAP IE may further include a user bitmap field indicating scheduled user equipments or non-scheduled user equipments, a deletion & resource hole bitmap field indicating deleted user equipments and a resource hole, and a scheduled user bitmap field indicating scheduled user equipments.

If the shifting indicator field is set to ‘0’, the GRA A-MAP IE may further include a user bitmap indicating scheduled user equipments if each bit is set to ‘1’ and indicating non-scheduled user equipment, a resource hole or deleted user equipments if each bit is set to ‘0’ and a deletion bitmap indicating deleted user equipments if each bit is set to ‘1’ and indicating a resource hole and non-scheduled user equipments if each bit is set to ‘0’, except for fields included in the GRA A-MAP IE if the shifting indicator field is set to ‘1’.

If the deletion indicator field is set to ‘0’, the GRA A-MAP IE may further include a user bitmap only, except for fields included in the GRA A-MAP IE if the deletion indicator field is set to ‘1’.

Also, the GRA A-MAP IE may further include a resource offset field indicating a subframe and a start LRU for resource allocation for a corresponding group.

FIG. 9 is a diagram illustrating that there is no shift of a user equipment, which is caused by reconfiguration of a user bitmap of the user equipment, and there are no user equipments deleted from a corresponding group.

In the GRA A-MAP IE of Table 5, if the deletion indicator is set to ‘0’, the user bitmap indicates whether user equipment is scheduled. ‘1’ of the user bitmap indicates scheduled user equipments, and HARQ feedback allocation (HFA) channels are allocated to the scheduled user equipments (AMS #1, #2, #5 and #7).

FIG. 10 is a diagram illustrating that user equipments are deleted from a corresponding group in accordance with the embodiment of the present invention.

In Table 5, if the deletion indicator is set to ‘1’ and the shifting indicator is set to ‘0’, the deletion bitmap is configured as much as the number of ‘0’ of the user bitmap. The deletion bitmap indicates whether user equipments are scheduled. For example, if the deletion bitmap is set to ‘1’, it indicates deleted user equipments. And, if the deletion bitmap is set to ‘0’, it indicates a resource hole and non-scheduled user equipments.

Referring to FIG. 10, in case of the DL A-MAP IE, the HARQ feedback allocation (HFA) channel is first allocated for the deleted user equipments, and then the HFA channel for the scheduled user equipments (AMS #1, #2 and #7) are allocated. In case of the UL A-MAP IE, the HFA channel is allocated for the deleted user equipments only.

In the embodiments of the present invention, the HFA channel is allocated to the deleted user equipments to identify whether the deleted user equipments have received the GRA A-MAP IE well. Also, the HFA channel for receiving ACK signal for DL data burst is allocated to the scheduled user equipments.

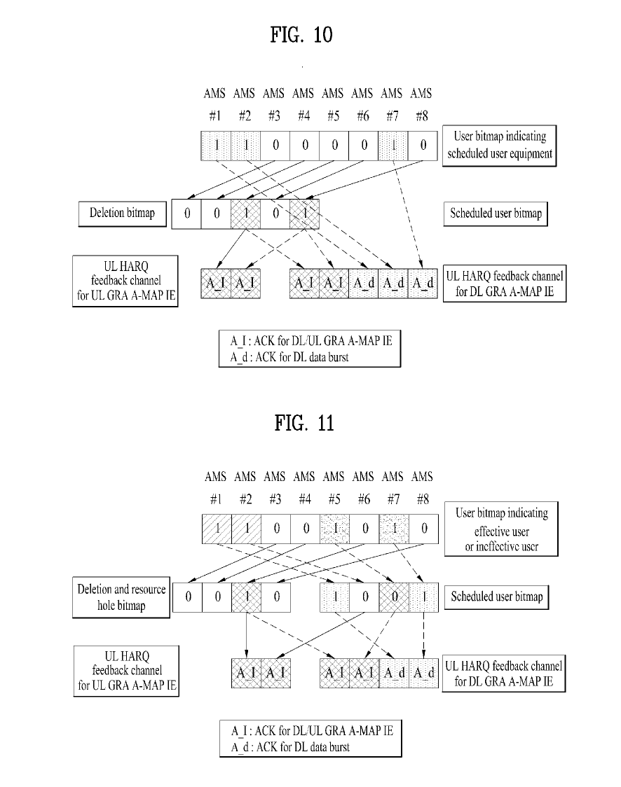

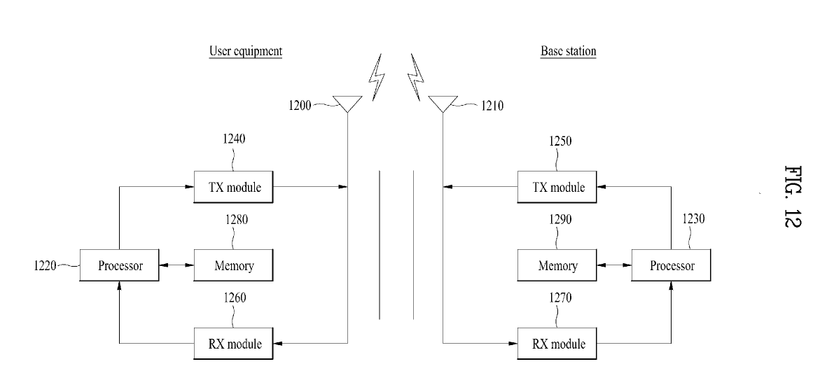

FIG. 11 is a diagram illustrating that deleted user equipments and shifted user equipments exist in accordance with the embodiment of the present invention.

It is assumed that both the deletion indicator and the shifting indicator in Table 5 are set to ‘1’. Since the shifting indicator is set to ‘1’, in the user bitmap, ‘1’ indicates scheduled user equipments and shifted user equipments, and ‘0’ indicates deleted user equipments or non-scheduled user equipments. In the deletion and resource hole bitmap, ‘1’ indicates deleted user equipments, and ‘0’ indicates a resource hole to which a resource is not allocated.

The HARQ feedback allocation channel is allocated to the deleted user equipments, the shifted user equipments and the scheduled user equipments in due order. Referring to FIG. 11, in case of the DL A-MAP IE, the HARQ feedback allocation (HFA) channel is first allocated for the deleted user equipments, and then the HFA channel for the scheduled user equipments (AMS #1 and #7) are allocated. In case of the UL A-MAP IE, the HFA channel is allocated for the deleted user equipments only.

FIG. 12 is a block diagram illustrating a user equipment and a base station through which the embodiments of the present invention described in FIG. 2 to FIG. 11 can be carried out.

The user equipment AMS may be operated as a transmitter in an uplink, whereas the user equipment may be operated as a receiver in a downlink. Also, the base station ABS may be operated as a receiver in the uplink, whereas the base station may be operated as a transmitter in the downlink.

In other words, each of the user equipment and the base station may include a transmission (Tx) module 1240, 1250 and a reception (Rx) module 1260, 1270 for controlling transmission and reception of information, data and/or message. Each of the user equipment and the base station may include an antenna 1200, 1210 for transmitting and receiving information, data and/or message. Also, each of the user equipment and the base station may include a processor 1220, 1230 for performing the aforementioned embodiments of the present invention, and a memory 1280, 1290 for storing temporarily or persistently a processing procedure of the processor.

In particular, the processor 1220, 1230 may further include a media access control entity for supporting and performing user bitmap reconfiguration disclosed in the embodiments of the present invention. Also, the user equipment and the base station of FIG. 12 may further include a low power radio frequency (RF)/intermediate frequency (IF) module.

The Tx module and the Rx module included in the user equipment and the base station may perform packet modulation and demodulation function for data transmission, quick packet channel coding function, orthogonal frequency division multiple access (OFDMA) packet scheduling, time division duplex (TDD) packet scheduling and/or channel multiplexing function.

The apparatuses described in FIG. 12 are the means through which the methods described in FIG. 2 to FIG. 12 may be carried out. The embodiments of the present invention may be performed using the elements and functions of the aforementioned user equipment and the base station.

The base station ABS may allocate the HARQ feedback allocation channel based on group resource allocation to the user equipment belonging to the group. If the user bitmap should be corrected, the processor 1230 of the base station may configure the GRA A-MAP IE described in Table 1 to Table 5 and transmit the configured GRA A-MAP IE to the user equipment through the Tx module 1250.

If the processor of the user equipment receives the GRA A-MAP IE from the base station, it may determine whether the user bitmap is reconfigured and identify the HARQ feedback allocation channel mapped with the user bitmap. If the user equipment should reconfigure its user bitmap, the processor 1220 of the user equipment may reconfigure the user bitmap by using the information included in the GRA A-MAP IE.

In the mean time, in the present invention, examples of the user equipment may include a personal digital assistant (PDA), a cellular phone, a personal communication service (PCS) phone, a global system for mobile (GSM) phone, a wideband CDMA (WCDMA) phone, a mobile broadband system (MBS) phone, a hand-held PC, a notebook PC, a smart phone, and a multi mode-multi band (MM-MB) terminal.

In this case, the smart phone is a terminal provided with advantages of a mobile communication terminal and a personal digital assistant (PDA). The smart phone may mean a terminal in which a schedule management function of the PDA and data communication functions of facsimile transmission/reception, internet access, etc. are integrated on a mobile communication terminal. Also, the multimode-multiband terminal means a terminal having a built-in multi-MODEM chip to be operable in a portable internet system and other mobile communication systems (e.g., CDMA (code division multiple access) 2000 system, WCDMA (wideband CDMA) system, etc.).

The embodiments according to the present invention may be implemented by various means, for example, hardware, firmware, software, or their combination.

If the embodiment according to the present invention is implemented by hardware, the embodiments of the present invention may be implemented by one or more application specific integrated circuits (ASICs), digital signal processors (DSPs), digital signal processing devices (DSPDs), programmable logic devices (PLDs), field programmable gate arrays (FPGAs), processors, controllers, microcontrollers, microprocessors, etc.

If the embodiment according to the present invention is implemented by firmware or software, the method according to the embodiments of the present invention may be implemented by a type of a module, a procedure, or a function, which performs functions or operations described as above. For example, a software code may be stored in the memory unit 1280, 1290 and then may be driven by the processor 1220, 1230. The memory unit may be located inside or outside the processor to transmit and receive data to and from the processor through various means which are well known.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein. It is also obvious to those skilled in the art that claims that are not explicitly cited in each other in the appended claims may be presented in combination as an embodiment of the present invention or included as a new claim by a subsequent amendment after the application is filed.

### INDUSTRIAL APPLICABILITY

The embodiments of the present invention may be applied to various wireless access systems. Examples of the various wireless access systems include 3GPP (3rd Generation Partnership Project), 3GPP2 and/or IEEE 802.xx (Institute of Electrical and Electronic Engineers 802) system. The embodiments of the present invention may be applied to all the technical fields based on the various wireless access systems, as well as the various wireless access systems.

1. A method for reconfiguring a user bitmap in group resource allocation (GRA), the method comprising the steps of:
receiving a control signal from a base station, the control signal including a shifting indicator for indicating whether the user bitmap should be reconfigured, a user bitmap status bitmap (UBSB) for indicating scheduled user equipments and non-scheduled user equipments, which belong to the GRA, and the user bitmap for indicating the scheduled user equipments;
determining on the basis of the control signal whether the user bitmap should be reconfigured; and
reconfiguring the user bitmap by using the UBSB and the user bitmap.

2. The method according to claim 1, wherein the control signal further includes a retransmission flag indicating whether the control signal is initially transmitted or retransmitted, and a retransmission bitmap indicating a user equipment which should reconfigure the user bitmap.

3. The method according to claim 2, wherein the control signal further includes a number (NDA) field indicating the number of deleted user equipments in the GRA, a user bitmap index field indicating a user bitmap index of the deleted user equipments, and a user bitmap size field indicating a length of the UBSB.

4. The method according to claim 2, wherein the control signal is a group resource allocation A-MAP information element.

5. A method for reconfiguring a user bitmap in group resource allocation (GRA), the method comprising the steps of:
determining whether the user bitmap should be reconfigured;
transmitting a control signal that includes a shifting indicator for indicating whether the user bitmap should be reconfigured, a user bitmap status bitmap (UBSB) for indicating scheduled user equipments and non-scheduled user equipments, which belong to the GRA, and the user bitmap for indicating the scheduled user equipments; and
receiving one of an acknowledgement (ACK) signal for downlink data burst, ACK signal for uplink data burst and ACK signal for the control signal after transmitting the control signal.

6. The method according to claim 5, wherein the control signal further includes a retransmission flag indicating whether the control signal is initially transmitted or retransmitted, and a retransmission bitmap indicating a user equipment which should reconfigure the user bitmap.

7. The method according to claim 6, wherein the control signal further includes a number (NDA) field indicating the number of deleted user equipments in the GRA, a user bitmap index field indicating a user bitmap index of the deleted user equipments, and a user bitmap size field indicating a length of the UBSB.

8. The method according to claim 6, wherein the control signal is a group resource allocation A-MAP information element.

9. A user equipment for reconfiguring a user bitmap in group resource allocation (GRA), the user equipment comprising:
a receiving means receiving a control signal from a base station, the control signal including a shifting indicator for indicating whether the user bitmap should be reconfigured, a user bitmap status bitmap (UBSB) for indicating scheduled user equipments and non-scheduled user equipments, which belong to the GRA, and the user bitmap for indicating the scheduled user equipments;
a determining means determining on the basis of the control signal whether the user bitmap should be reconfigured; and
a reconfiguring means reconfiguring the user bitmap by using the UBSB and the user bitmap.

10. The user equipment according to claim 9, wherein the control signal further includes a retransmission flag indicating whether the control signal is initially transmitted or retransmitted, and a retransmission bitmap indicating a user equipment which should reconfigure the user bitmap.

11. The user equipment according to claim 10, wherein the control signal further includes a number (NDA) field indicating the number of deleted user equipments in the GRA, a user bitmap index field indicating a user bitmap index of the deleted user equipments, and a user bitmap size field indicating a length of the UBSB.

12. The user equipment according to claim 10, wherein the control signal is a group resource allocation A-MAP information element.
